(19) United States
(12) Patent Application Publication
(10) Pub. No.: US 2011/0060575 A1
(43) Pub. Date: Mar. 10, 2011

(54) Method for Generating Information of a 3-Dimensional Molecular Structure of a Molecule

(75) Inventors: Jacob Ary Flohil, Delft (NL); Maarten Gijsbrecht Wolf, Golligen (DE); Simon Walterus De Leeuw, Delft (NL)

(73) Assignee: Technische Universiteit Delft, Delft (NL)

(21) Appl. No.: 12/819,596

(22) Filed: Jun. 21, 2010

Related U.S. Application Data
(63) Continuation of application No. PCT/NL2008/050821, filed on Dec. 19, 2008.

(30) Foreign Application Priority Data
Dec. 19, 2007 (NL) 2001101

(51) Int. Cl. G06G 7/48

(52) U.S. Cl. 703/11; 703/12

(57) ABSTRACT

A method for generating information of a 3-dimensional molecular structure of a molecule, said method being executable by a computer under the control of a program stored in the computer, said method comprising the steps of: (a) receiving a 3-dimensional representation of the molecular structure of said molecule, comprising a first set of residue portions and a template; (b) repeating an optimization cycle, wherein a set of (b1) modifying the molecular structure of one or more of the first set of residue portions, (b2) relaxing said modified structure, and (b3) calculating an energy value of the structure and comparing said calculated value with a prestored base value or with a value calculated in a previously performed step (b3), is repeated; (c) until a predetermined criterion is fulfilled; and (d) outputting a data structure comprising information extracted from any of these steps to a storage medium or to a consecutive method. Preferably the 3-dimensional representation of said molecule comprises a set of hydrogen residues and step (b3) comprises the step of calculating the energy value of hydrogen bridges in the structure, and wherein said criterion of step (c) is comprised of a difference between the calculated value and the prestored base value or the previously calculated value.

### CROSS-REFERENCE TO RELATED APPLICATIONS

This application is a continuation application of International Patent Application Serial No. PCT/NL2008/050821, entitled “A Method for Generating Information of a 3-Dimensional Molecular Structure of a Molecule”, to Technische Universiteit Delft, filed on Dec. 19, 2008, which is a continuation of Netherlands Patent Application Serial No. 2001101, entitled “A Method for Generating Information of a 3-Dimensional Molecular Structure of a Molecule”, to Technische Universiteit Delft, filed on Dec. 19, 2007, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable,

### COPYRIGHTED MATERIAL

Not Applicable.

### BACKGROUND OF THE INVENTION

1. Field of the Invention (Technical Field)

The present invention relates to a method for generating information of a 3-dimensional molecular structure of a molecule as mentioned in the preamble of claim 1. The invention also relates to a computing device and a computer program as mentioned in the independent claims 8 and 9.

2. Description of Related Art

A method as identified above is known from EP 1 226 528. Said method is generally known in the art since many-years (the “Faster” method). This publication EP 1 226 528 relates to a method for generating information related to the molecular structure of a biomolecule, the method being executable by a computer under the control of a program stored in the computer and comprising the steps of: (a) receiving a three-dimensional representation of the molecular structure of said biomolecule, the said representation comprising a first set of residue portions and a template; (b) modifying the representation of step (a) by at least one optimization cycle; wherein each optimization cycle comprises the steps of: (b1) perturbing a first representation of the molecular structure by modifying the structure of one or more of the first, set of residue portions by means of a supplemental force field acting on at least said first set of residue portions; (b2) relaxing the perturbed representation by disabling the supplemental force field; (b3) evaluating the perturbed and relaxed representation of the molecular structure by using an energetic cost function and replacing the first representation by the perturbed and relaxed representation if the latter's global energy is more optimal than that of the first representation; and (c) terminating the optimization process according to step (b) when a predetermined termination criterion is reached; and (d) outputting to a storage medium or to a consecutive method a data structure comprising information extracted from step (b). The contents of EP 1 226 528 are herewith incorporated by reference in its entirety.

This known method has several disadvantages. For example, only the main chain (the template) and the side chains are taken into account for calculating the energy value of different conformational structures. Upon bending the molecular structure, only the energy values of these main chain and side chains are calculated. With the Faster method, the main chain will never move during the search calculation, since the backbone atoms positions are fixed without exception and provide the essential information to position the side chains within the main chain frame. In molecular dynamics, all atoms are in constant motion, possessing kinetic energy (at for example 300 Kelvin) and experiencing potential energy described by a Hamiltonian function. During the cycles there is no (0 Kelvin) energy minimization (as is used frequently in other methods to obtain acceptable molecular conformations) but excess energy in the system as a result of the cyclic intervention is removed as excess heat through the thermostatic (300 Kelvin) coupling of the Berendsen bath.

### BRIEF SUMMARY OF THE INVENTION

The present, invention aims at providing an improved method. The improvement concerns the use of MD as basic and physical reliable simulation engine and is guided by the potentials that are imposed by interactive and cyclic intervention of a hydrogen bond search algorithm. This search algorithm is able to detect possible hydrogen bond formation and breaking within a wider range then is possible with MD. Guiding forces are not represented by spring-like harmonic forces which increase quadratically with the distance but by applying forces that increase during time cycles and are driven by crossing barrier events. The enhancement of correctly recognized hydrogen bond networks accelerates MD simulation and increases the production of molecular events (for example formation of a hydrogen bond) with a factor up to 1000 times over classical simulation. Another very important feature is that the recognition of optimal hydrogen bond networks and the guiding directives to the realization of these networks helps the MD to follow very efficiently the high-dimensional pathway of least resistance towards the global energy minimum.

### BRIEF DESCRIPTION OF THE SEVERAL VIEWS OF THE DRAWINGS

Not Applicable.

### DETAILED DESCRIPTION OF THE INVENTION

The present, invention aims at providing an improved method. The improvement concerns the use of MD as basic and physical reliable simulation engine and is guided by the potentials that are imposed by interactive and cyclic intervention of a hydrogen bond search algorithm. This search algorithm is able to detect possible hydrogen bond formation and breaking within a wider range then is possible with MD. Guiding forces are not represented by spring-like harmonic forces which increase quadratically with the distance but by applying forces that increase during time cycles and are driven by crossing barrier events. The enhancement of correctly recognized hydrogen bond networks accelerates MD simulation and increases the production of molecular events (for example formation of a hydrogen bond) with a factor up to 1000 times over classical simulation. Another very important feature is that the recognition of optimal hydrogen bond networks and the guiding directives to the realization of these networks helps the MD to follow very efficiently the high-dimensional pathway of least resistance towards the global energy minimum.

The invention also aims at providing a more accurate and more reliable method.

Finally, the invention aims at providing a faster method for generating information of a 3-dimensional molecular structure of a molecule.

To obtain at least one of the aforementioned goals, the invention provides a method comprising the steps as indicated in claim 1. It has shown that using hydrogen bridge energy for calculating the energy value of the structure of the molecule provides an improved method. It has also shown that the method reaches said predetermined criterion faster and more accurately.

The method has become more reliable with the steps according to the present invention.

Preferably, this is obtainable when the following steps (b2) and (b3) are performed in the method as generally indicated above: (b2) thermodynamically relaxing atomic motions of the perturbed representation by disabling the supplemental force field while maintaining the running of the simulation by a classical molecular dynamics engine; and (b3) evaluating the perturbed and molecular dynamics relaxed representation of the molecular structure by using an energetic cost function (derived from the Hamiltonian equations of motion that governs the atomic motions over time) and replacing the first representation by the perturbed and relaxed representation if the latter's global energy is more optimal than that of the first representation. Then steps (c) and further are continued, as have already been described above.

As a matter of fact, the hydrogen atoms that will form hydrogen bridges are those attached to oxygen or nitrogen atoms.

According to the invention, a hydrogen bond potential V_{hb} is introduced as a supplemental force to the standard (gromos 96) force field (for example, the Amber or Charmm force field used in the method of EP 1 226 528), which acts on the atoms involved in hydrogen bonding in order to accelerate protein folding in MD simulations. This is implemented as a staged molecular dynamics protocol, where according to the present invention three stages are distinguished: the repulsive stage (“R”), the attractive stage (“A”) and the relaxation stage (“E”). These three stages each treat hydrogen bonds differently. In “R” a potential stimulates hydrogen bond breakage, in “A” a potential facilitates hydrogen bond formation and in “E” the system is allowed to relax thermodynamically at about 300 Kelvin by removing all forces derived from the supplementary force field and running the MD simulation stand-alone. In the present simulations each stage is active for, for example, 0,5 ps in the order-(-R-E-A-E-)-ₙ.

When a stage is active (for example 0,1 ps), all intramolecular donor-acceptor pairs of a protein are evaluated in every time frame. The relevant pairs are selected and potentials are introduced that will result in a force acting on the atoms. A pair is excluded from selection if it (a) is a strong hydrogen bond (characterized by a donor-acceptor distance less than for example 0.35 nm and a donor-hydrogen-acceptor angle larger than for example 120°), (b) the atoms of the pair are involved in another strong hydrogen bond and (c) the atoms in the pair are already targeted in another hydrogen bond potential (e.g. from a previous evaluation). For the remaining donor-acceptor pairs those with the largest hydrogen bond potential energy (eq. 1) are selected, with the rule that the atoms in a pair may only be selected once.

Regarding the potential used, please note as follows:

The hydrogen bond potential V_{hb}(q,t) is given in (eq. 1).

V_{hb}(q,t)=fc(q,t)·E_{d}(q(tₑᵥ))·E_{θ}(q(tₑᵥ)) (eq. 1)

It is a function of time t and consists of a distance potential E_{d}(q(tₑᵥ)), an angle potential E_{d}(q(tₑᵥ)) a time-dependent force constant f c(q,t) and the positions of the atoms in the hydrogen bonds q.

In the repulsive stage the distance potential E_{d}(q(tₑᵥ)) is determined by the distance d (nm) between donor and acceptor (FIG. 1) at the evaluation time tₑᵥ. Cutoff distances dₘᵢₙ and dₘₐₓ of (for example) 0.35 and 0.40 nm are used respectively. For the attractive stage the distance between hydrogen and acceptor (FIG. 1) is considered and the cutoff distances dᵣₐᵢₙ and dₘₐₓ are (for example) 0.35 and 0.40 nm, respectively. For the attractive stage the distance between hydrogen and acceptor (FIG. 1) is considered and the cutoff distances dₘᵢₙ and dₘₐₓ, are (for example) 0.23 and 40 nm, respectively. The values of the cutoff distances ensure that only weak to very weak hydrogen bonds are targeted.

$${E}_{d} ( q ( {t}_{ev} ) ) = \{ \begin{matrix}1 & d ( {t}_{ev} ) < {d}_{min} \\ 1 - \frac{d ( {t}_{ev} ) - {d}_{min}}{{d}_{max} - {d}_{min}} & {d}_{min} \leq d ( {t}_{ev} ) < {d}_{max} \\ 0 & {d}_{max} \leq d ( {t}_{ev} )\end{matrix} \qquad ( eq . 2 )$$

The angle potential E_{θ}(q(tₑᵥ)) depends on the angle θ (degrees) of the donor hydrogen acceptor (FIG. 1) at activation time tₑᵥ. The cutoff angle θ_{bound} in the repulsive stage is in this case set to 120°, which ensures targeting all weak hydrogen bonds, and in the attractive stage to 60° (although other values may be chosen as well), allowing generation of many hydrogen bonds.

$${E}_{θ} ( q ( {t}_{ev} ) ) = \{ \begin{matrix}1 & θ ( {t}_{ev} ) \geq {θ}_{bound} \\ 0 & {θ}_{bound} > θ ( {t}_{ev} )\end{matrix} \qquad ( eq . 3 )$$

An important concept of the present invention is that the individual forces, applied in each selected donor-acceptor atom pair in the thermodynamic system may increase gradually during a cycle, until a barrier crossing event is received at. Then, the forces (potentials) will diminish and they will be set to a value “zero” at the end of said cycle.

The time-dependent force constant ensures a gradual introduction of the forces in the system. It is a function of the maximum force constant fcₘₐₓ (kJ mol⁻¹ nm⁻¹) and the gradual force introduction time t_{grad} (ps)·t_{grad} initially has the value zero. It is increased by one every timestep as long as the hydrogen bond it acts upon is within the distance potential cutoff, i.e., dₘᵢₙ≦dₜ<dₘₐₓ. When outside this range, one is subtracted. If this sum becomes smaller than 0 t_{grad} is set to 0. t_{grad} ensures that when the hydrogen bond is within the distance potential boundaries the force is introduced within 50 timesteps (division factor in (eq. 4)) to its maximum value and when outside these boundaries it is slowly decreased to zero. The division factor is chosen arbitrarily, within the idea of gradually introducing the forces in the system to its maximum. To obtain the maximum force constant several values were tested and the values showing a good response, i.e. many unfolding and folding events, were used.

$$fc ( q , t ) = {fc}_{max} \cdot min \{ 1 , \frac{{t}_{grad}}{50} \} \qquad ( eq . 4 )$$

The hydrogen bond potential leads to the introduction of the following force acting on the acceptor atom (FIG. 1).

$${F}_{A} = fc ( q , t ) \cdot \{ \begin{matrix}\frac{1}{{d}_{max} - {d}_{min}} \frac{{d}_{XA} ( {t}_{ev} )}{{d}_{XA} ( {t}_{ev} )} & {d}_{min} \leq d ( {t}_{ev} ) < {d}_{max} ; θ ( {t}_{ev} ) \geq {θ}_{bound} \\ 0 & rest\end{matrix} \qquad ( eq . 5 )$$

The balancing force is F_{X}=-F_{A}. In these equations the X refers to the donor atom in the repulsive stage and to the hydrogen atom in the attractive stage (FIG. 1).

Preferred embodiments are specifically identified in the dependent claims. The advantages of said embodiments will become clear after the extensive discussion of the invention, given below.

As a matter of fact, EP 1 226 528 mentions the use of the contribution of hydrogen bonds in the molecule. However, this is only for determining the energy values between the atoms in the main chain and side chains, since the presence of a hydrogen atom on a side chain or a main chain influences the energy value between atoms in the main chain and side chains. The energy contribution of hydrogen bridges is in general not taken into account. According to the above identified European patent publication EP 1 226 528 the conformation of the main chain is not amended when alterations in the hydrogen bonds or hydrogen bridges are obtained. Furthermore, when the method according to said European patent advances, single residues are removed from the optimization cycle whereas portions (clusters of residues) only are used for calculating the global energy of the molecule.

In general terms, the present invention accelerates protein folding in all atom molecular dynamics simulations by introducing alternating hydrogen bond potentials as a supplement to the force field. The alternating hydrogen bond potentials result in accelerated hydrogen bond reordering, which lead to quick formation of secondary structure elements. The method does not require knowledge of the native state, but generates the potentials based on the development of the tertiary structure in the simulation. In protein folding the formation of secondary structure elements, especially a-helix and n-sheet, is very important and we show that our method can fold both efficiently and with great speed.

Folding of a protein into the native state cannot be described by a random search through all the degrees of freedom, but is believed to be a guided process.

The method according to the invention is applicable not only to interactions within the same biomolecule, but also to interactions with one or more different molecules, optionally as a complex of said biomolecule with a different molecule.

Here we propose a novel computational method based on the idea that occasional (partial) unfolding of a protein enhances the frequency of barrier crossing and the folding rate of proteins. We perform molecular dynamics (hereinafter identified as MD) simulations during which we periodically introduce temporary supplemental (additional) forces that alternatingly stimulate unfolding and folding. These forces act on the intramolecular hydrogen bonds. The first reason for this is because distinct hydrogen bonds in a similar context contribute equally to the free energy, but a free energy barrier separates all the possible hydrogen bonds. In other words, hydrogen bonds provide kinetic stability both in the global minimum and in local minima rather than thermodynamic stability. This has important implications: unfolding and folding can be stimulated by reimbursing the activation energy set by the kinetic barrier of a hydrogen bond. In addition the hydrogen bonds provide specificity rather than stability with respect to the tertiary structure of a protein, which means that the interactions that provide thermodynamic stability are unaltered and still guide the folding process of the protein into its native state, while the time in free-energy minima is decreased. A second more technical reason for influencing the intramolecular hydrogen bonds is that the number of required additional forces is minimal. This is because the number of donor-acceptor pair combinations in a protein is limited and the hydrogen bonds are orientation dependent, requiring introduction of only a few relevant hydrogen bond potentials.

The manipulation of the hydrogen bonds is performed within a single MD simulation, where alternatingly attractive or repulsive hydrogen bond potentials are introduced in addition to the standard force field potentials. The repulsive potential destabilizes the hydrogen bonds and lifts the protein to a higher free-energy level. The attractive potential in turn facilitates hydrogen bond formation to enable a fast identification of the conformational regions of free-energy minima. Such local unfolding/folding mechanism would be comparable with the barrier crossing effect of a chaperone protein. In this method we do not need a priori information on the native state; rather we use the structure of the protein as it develops during the simulation to determine which potentials are introduced.

We show that manipulation of hydrogen bonds during an MD simulation can accelerate the folding of a protein. The two secondary structure elements appearing most, a-helix and β-sheet, can be folded efficiently. This is demonstrated by the folding of a 16 residue polyalanine to the a-helical native state and the 16 residue C-terminal of the 1 GB1 protein to the β-hairpin native state.

The method presented above aims to accelerate in silico protein folding. This is achieved by manipulating the intramolecular hydrogen bonds, leading to an increase in the number of barrier transitions. To show that this is indeed the case, the time behavior of a 16-residue polyalanine was examined with standard MD (4 simulations of 30 ns) and with AHBP-MD (5 simulations of 10 ns). The simulations were started from a collapsed coil, which represent a structure in a local minimum possessing many hydrogen bonds. The maximum force constant used in the MD simulation including AHBP were −600 kJ mol^{-l} nm⁻¹ for the attractive potential and 450 kJ mol⁻¹ nm⁻¹ for the repulsive potential.

To test if the faster and broader sampling of the conformational space of a protein by the AHBP-MD simulations leads to fast formation of secondary structure elements two systems were tested. The polyalanine simulations used to show enhanced barrier crossing in AHBP-MD were also used to test the ability of the AHBP method to form a-helical secondary structure. To test the 13-sheet secondary structure formation we investigated the folding of the 16 residue C-terminus of the protein G (PDB-code 1 GB1), which adopts β-hairpin conformation in an aqueous environment. We performed 10 standard MD simulations of 50 ns and 10 AHBP-MD simulations of 30 ns, which all started from an extended conformation. In these AHBP-MD simulations of the β-hairpin we used a maximum force constant of −300 and 900 kJ mol⁻¹ nm' for the attractive and the repulsive potential respectively.

For the polyalanine simulations the average number of residues in an a-helical conformation is determined. The N- and C-terminus are not taken into account since they are too mobile. From this, it is clear that within the very short time of the AHBP simulation fast formation of a-helix secondary structure occurs. The fastest formation of a full helix is observed within 6 ns and all simulations show formation of a-helical structure elements. In our four standard MD simulations we observe only one short instance of a-helix formation, confirming that a-helix formation is much faster and more abundant when AHBP is turned on.

To test for β-sheet formation in the simulation of the folding of 1 GB1 β-hairpin, we determined the average number of residues in a n-sheet conformation versus simulation time. In the AHBP-MD simulations a steady rise of the number of residues in a n-sheet conformation is observed, while in the standard MD simulations this number is not as high and not as consistent. So in addition to a-helix formation, AHBP-MD simulations can also lead to fast formation of β-sheet secondary structure.

What is claimed is:

1. A method for generating information of a 3-dimensional molecular structure of a molecule, said method being executable by a computer under the control of a program stored in the computer, said method comprising the steps of:
(a) receiving a 3-dimensional representation of the molecular structure of said molecule, comprising a first set of residue portions and a template;
(b) repeating an optimization cycle, wherein a set of:
(b1) modifying the molecular structure of one or more of the first set of residue portions,
(b2) relaxing said modified structure, and
(b3) calculating an energy value of the structure and comparing said calculated value with a prestored base value or with a value calculated in a previously performed step (b3), is repeated;
(c) until a predetermined criterion is fulfilled; and
(d) outputting a data structure comprising information extracted from any of these steps to a storage medium or to a consecutive method, wherein the 3-dimensional representation of said molecule comprises a set of hydrogen residues and step (b3) comprises the step of calculating the energy value of hydrogen bridges in the structure, and wherein said criterion of step (c) is comprised of a difference between the calculated value and the prestored base value or the previously calculated value,

2. A method according to claim 1, wherein the 3-dimensional representation of said molecule comprises a set of oxygen bonded or nitrogen bonded hydrogen residues.

3. A method according to claim 1, wherein said hydrogen residues form part of said first set of residue portions.

4. A method according to claim 1, wherein the energy value of said hydrogen bridges is calculated and added to the energy value of the structure.

5. A method according to claim 1, wherein said molecule is a biomolecule.

6. A method according to claim 5, wherein said biomolecule is a polypeptide, a polynucleotide, a polysaccharaide, and a complex comprising at least one biologically active (macro) molecule.

7. A method according to claim 5, wherein said biomolecule shows interaction with one or more different molecules and wherein said method comprises the step of (2) receiving a 3-dimensional representation of the molecular structure of said biomolecule with said one or more different molecule.

8. A computing device for generating information of a 3-dimensional molecular structure of a molecule, said computing device comprising:
(a) means for receiving a 3-dimensional representation of the molecular structure of said molecule, comprising a first set of residue portions and a template;
(b) means for repeating an optimization cycle, comprised of
(b1) modifying the molecular structure of one or more of the first set of residue portions,
(b2) relaxing said modified structure, and
(b3) calculating an energy value of the structure and comparing said calculated value with a prestored base value or with a value calculated in a previously performed (b3);
(c) means for terminating the optimization cycle when a predetermined criterion is fulfilled; and
(d) means for outputting a data structure comprising information extracted from any of these steps to a storage medium or to a consecutive method, wherein the means for receiving a 3-dimensional representation of the molecular structure of said molecule comprise means for receiving a set of hydrogen residues and wherein the means (b) comprise means for calculating the energy value of hydrogen bridges in the structure in (b3).

9. A software product stored on a computer-readable medium and adapted to be executed on a computing device, the product comprising software for:
(a) receiving a 3-dimensional representation of the molecular structure of said molecule, comprising a first set of residue portions and a template;
(b) repeating an optimization cycle, comprised of:
(b1) modifying the molecular structure of one or more of the first set of residue portions,
(b2) relaxing said modified structure, and
(b3) calculating an energy value of the structure;
(c) until a predetermined criterion is fulfilled; and
(d) outputting a data structure comprising information extracted from any of these steps to a storage medium or to a consecutive method, wherein the product is adapted for calculating the energy value of hydrogen bridges and adding said value to the energy value of the structure.

10. A method according to claim 1, wherein a cutoff angle θ_{bound} in the repulsive stage is set to 100°-140° and in the attractive stage to 45°-75°.

11. A method according to claim 1, wherein a donor-acceptor distance is less than 0.50 nm and a donor-hydrogen-acceptor angle is larger than 100°.

12. A method according to claim 1, wherein cutoff distances dₘᵢₙ and dₘₐₓ of about 0.35 and 0.40 nm are used, respectively.

13. A method according to claim 1, wherein in the attractive stage the cutoff distances dₘᵢₙ and dₘₐₓ, are about 0.23 and 0.40 nm, respectively.

14. A method according to claim 1, wherein the time frame in the step of (b1) and (b2) has a value of between 0.05 to 0.20 ps.

15. A method according to claim 7, wherein said method comprises receiving a 3-dimensional representation of the molecular structure of said biomolecule in complex with said one or more different molecules.

16. A method according to claim 10, wherein the cutoff angle θ_{bound} in the repulsive stage is set to 120°.

17. A method according to claim 10, wherein the cutoff angle θ_{bound} in the attractive stage is set to 60°.

18. A method according to claim 11, wherein the donor-acceptor distance is less than 0.40 nm.

19. A method according to claim 11, wherein the donor-acceptor distance is less than about 0.35 nm.

20. A method according to claim 11, wherein the donor-hydrogen-acceptor angle is larger 110°,

21. A method according to claim 11, wherein the donor-hydrogen-acceptor angle is larger than 120°.

22. A method according to claim 14, wherein the time frame in the step of (b1) and (b2) has a value of about 0.1 ps.
